(19) United States
(12) Patent Application Publication
(10) Pub. No.: US 2014/0180627 A1
(43) Pub. Date: Jun. 26, 2014

(54) SYSTEM, METHOD AND/OR DEVICES FOR APPLYING MAGNETIC SIGNATURES FOR POSITIONING

(71) Applicant: QUALCOMM INCORPORATED, San Diego, CA (US)

(72) Inventors: Ayman Fawzy Naguib, Cupertino, CA (US); Charles A. Bergan, Cardiff, CA (US); Sameera Poduri, Santa Clara, CA (US); Payam Pakzad, Mountain View, CA (US)

(73) Assignee: QUALCOMM INCORPORATED, San Diego, CA (US)

(21) Appl. No.: 13/723,046

(22) Filed: Dec. 20, 2012

(51) Int. Cl. G01C 21/08

(52) U.S. Cl. CPC G01C 21/08
USPC 702/150

(57) ABSTRACT

Disclosed are systems, methods and devices for application of measurements obtained from a compass or magnetometer in estimating a location of a mobile device. In specific implementations, expected signatures of local magnetic fields at locations are provided to a mobile device as positioning assistance data. In other implementations, magnetic measurements obtained by multiple mobile devices at identifiable locations in an indoor area may be combined for deriving expected signatures of local magnetic fields for use in positioning assistance data.

### BRIEF DESCRIPTION

1. Field

Embodiments described herein are directed to mobile navigation techniques.

2. Information

Hand-held mobile devices, such as cellphones, personal digital assistants, etc., are typically enabled to receive location based services through the use of location determination technology including satellite systems (SPS'), indoor location determination technologies and/or the like. In addition, some hand-held mobile devices include inertial sensors to provide signals for use by a variety of applications including, for example, receiving hand gestures as user inputs or selections to an application, orientation of a navigation display to an environment, just to name a couple of examples. Here, signals and/or measurements obtained from such inertial sensors may be used to determine an orientation of a mobile device relative to a reference, interpret hand controlled movements as inputs, just to name a few examples.

Inertial sensors on a mobile device typically provide 3-dimensional sensor measurements on an x,y,z-axis defining a Cartesian coordinate system. For example, an accelerometer may provide acceleration measurements in x,y,z directions. In particular examples, an accelerometer may be used for sensing a direction of gravity toward the center of the earth and/or direction and magnitude of other accelerations. Similarly, a magnetometer may provide magnetic measurements in x,y,z directions. Magnetometer measurements may be used, for example, in sensing a polar magnetic field in a true North direction for use in navigation applications. Gyroscopes, on the other hand, may provide angular rate measurements in roll, pitch and yaw dimensions.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a system diagram illustrating certain features of a system containing a mobile device, in accordance with an implementation.

FIG. 2 is a map of an indoor area showing a path traveled by a mobile device according to an embodiment.

FIG. 3 is a path of a mobile device traveled in an indoor area estimate based, at least in part, on magnetometer measurements in the presence of one or more local magnetic fields, according to an embodiment.

FIG. 4 is a path of a mobile device traveled in an indoor area estimate based, at least in part, on gyroscope measurements, according to an embodiment.

FIG. 5 shows a heading of a mobile device relative to a local magnetic field and true-North direction, according to an embodiment.

FIG. 6 is a flow diagram of a process to collect magnetic measurements at a mobile device, according to an embodiment.

FIG. 7 is a flow diagram of a process to determine and distribute expected magnetic signatures for use as positioning assistance data according to an embodiment.

FIG. 8A is a flow diagram of a process to apply measurements of a local magnetic field for estimating a location of a mobile device, according to an embodiment.

FIG. 8B is a flow diagram of a process to apply measurements of a local magnetic field for estimating an orientation or heading of a mobile device, according to an embodiment.

FIG. 9 is a schematic block diagram illustrating an exemplary mobile device, in accordance with an implementation.

FIG. 10 is a schematic block diagram of an example computing platform in accordance with an implementation.

### SUMMARY

In one particular implementation, a method at a mobile device comprises: receiving signals from a magnetometer generated, at least in part, in response to a polar magnetic field; correlating the received signals with a signature indicative of a local magnetic field; and estimating a location of the mobile device based, at least in part, on the signature correlated with the received signals.

In another particular implementation, a mobile device comprises: a magnetometer to generate signals at least in part in response to a polar magnetic field; and a processor to: correlate the generated signals with a signature indicative of a local magnetic field; and estimate a location of the mobile device based, at least in part, on the signature correlated with the generated signals.

In another particular implementation, an article comprises: a non-transitory storage medium comprising machine-readable instructions stored thereon which are executable by a special purpose computing apparatus to: obtain from messages originating at a plurality of mobile devices measurement locations in an indoor area in association with measurements of magnetic fields local to said measurement locations; develop expected magnetic signatures over locations in said indoor area based, at least in part, on a combination of the measurements obtained from the mobile devices; and initiate transmission of the expected magnetic signatures to other mobile devices as indoor positioning assistance data.

In another particular implementation, an apparatus comprises: means for receiving messages from a plurality of mobile devices including measurement locations in an indoor area in association with measurements of a local magnetic field obtained at said measurement locations; means for developing expected magnetic signatures over locations in the indoor area based, at least in part, on a combination of the measurements obtained from the mobile devices; and means for transmitting the expected magnetic signatures to other mobile devices as indoor positioning assistance data.

In another implementation, a method at a mobile device comprises: obtaining an estimated location of the mobile device; obtaining a first estimated heading of the mobile device based, at least in part, on one or more measurements obtained from a magnetometer; obtaining a second estimated heading of the mobile device independently of the one or more measurements obtained from the magnetometer; estimating a compass deviation based, at least in part, on the first and second estimated headings; and transmitting one or more messages to a server comprising the estimated compass deviation in association with the estimated location.

In another particular implementation, a mobile device comprises: a magnetometer to generate measurements responsive to a magnetic field; a transmitter to transmit messages through a communication network; and a processor to: obtain a first estimated heading of the mobile device based, at least in part, on one or more measurements obtained from the magnetometer; obtain a second estimated heading of the mobile device independently of the one or more measurements obtained from the magnetometer; estimate a compass deviation based, at least in part, on the first and second estimated headings; and initiate transmission of one or more messages through the transmitter to a server, the one or more messages comprising the estimated compass deviation in association with the estimated location.

In another particular implementation, an article comprises: a non-transitory storage medium comprising machine-readable instructions stored thereon which are executable by a special purpose computing apparatus to: compute a first estimated heading of a mobile device based, at least in part, on one or more measurements obtained from a magnetometer; compute a second estimated heading of the mobile device independently of said one or more measurements obtained from the magnetometer; estimate a compass deviation based, at least in part, on the first and second estimated headings; and initiate transmission of one or more messages to a server, the one or more messages comprising the estimated compass deviation in association with the estimated location.

In yet another particular implementation, an apparatus comprises: means for obtaining an estimated location of the mobile device; means for obtaining a first estimated heading of the mobile device based, at least in part, on one or more measurements obtained from a magnetometer; means for obtaining a second estimated heading of the mobile device independently of the one or more measurements obtained from said magnetometer; means for estimating a compass deviation based, at least in part, on said first and second estimated headings; and means for transmitting one or more messages to a server comprising said estimated compass deviation in association with said estimated location.

In yet another implementation, a method comprises, at a mobile device: receiving signals from a magnetometer generated, at least in part, in response to a polar magnetic field; correlating said received signals with a signature indicative of a local magnetic field; and estimating an orientation or heading of the mobile device based, at least in part, on said signature correlated with said received signals.

In yet another implementation, a mobile device comprises: a magnetometer to generate signals at least in part in response to a polar magnetic field; and a processor to: correlate said received signals with a signature indicative of a local magnetic field; and estimating an orientation or heading of the mobile device based, at least in part, on said signature correlated with said received signals.

In yet another implementation, an article comprises: a non-transitory storage medium comprising machine-readable instructions stored thereon which are executable by a special purpose computing apparatus at a mobile device to: correlate said received signals with a signature indicative of a local magnetic field; and estimate an orientation or heading of the mobile device based, at least in part, on said signature correlated with said received signals.

In yet another implementation, an apparatus comprising: means for receiving signals from a magnetometer at a mobile device, the signals being generated, at least in part, in response to a polar magnetic field; means for correlating said received signals with a signature indicative of a local magnetic field; and means for estimating an orientation or heading of the mobile device based, at least in part, on said signature correlated with said received signals.

It should be understood that the aforementioned implementations are merely example implementations, and that claimed subject matter is not necessarily limited to any particular aspect of these example implementations.

### DETAILED DESCRIPTION

Indoor navigation applications may incorporate measurements of radio frequency (RF) signals received at a mobile device and transmitted from local transmitters positioned at known locations to track to the position of a mobile device. In combination with measurements taken from acquired RF signals, an indoor navigation application may also incorporate accelerometer traces using a motion model, such as a particle filter, to track the position of a mobile device. While magnetometer signals may be effective in measuring a heading of mobile device in an outdoor environment, ferromagnetic disturbances in an indoor environment (e.g., concentrations of ferromagnetic material and electronic equipment) may make a magnetometer reading unreliable indicators of heading relative to true North.

In a particular implementation, a navigation application may leverage a signature of expected magnetic behavior at points along a map of an indoor area. Here, a “heatmap” of signature values characterizing expected magnetic behavior at particular locations in an indoor area may be provided to a mobile device as assistance data (e.g., in addition to other positioning assistance data). Such a heatmap may reflect expected deviations of a local magnetic field from a polar magnetic field at particular locations. In one application, a mobile device may estimate its position based, at least in part, on a correlation of magnetometer signal measurements with one or more heatmap signature values.

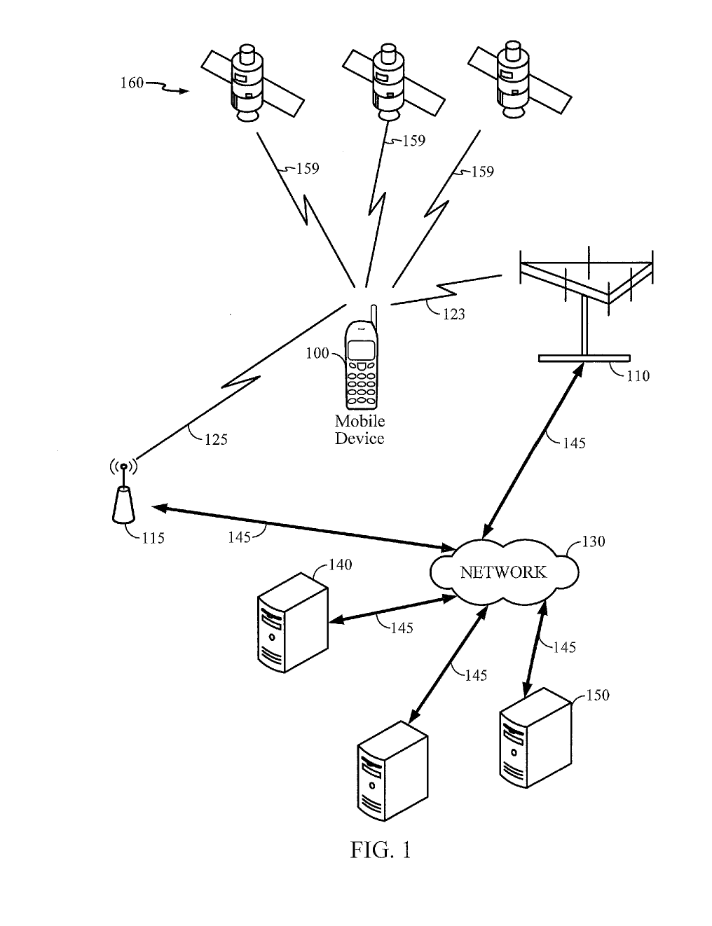

In certain implementations, as shown in FIG. 1, a mobile device 100 may receive or acquire satellite positioning system (SPS) signals 159 from SPS satellites 160. In some embodiments, SPS satellites 160 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS') such as, for example, Wide Area Augmentation System (WAAS), European Geostationary Navigation Overlay Service (EGNOS), Quasi-Zenith Satellite System (QZSS), just to name a few examples.

In addition, the mobile device 100 may transmit radio signals to, and receive radio signals from, a wireless communication network. In one example, mobile device may communicate with a cellular communication network by transmitting wireless signals to, or receiving wireless signals from, a base station transceiver 110 over a wireless communication link 123. Similarly, mobile device 100 may transmit wireless signals to, or receive wireless signals from a local transceiver 115 over a wireless communication link 125.

In a particular implementation, local transceiver 115 may be configured to communicate with mobile device 100 at a shorter range over wireless communication link 125 than at a range enabled by base station transceiver 110 over wireless communication link 123. For example, local transceiver 115 may be positioned in an indoor environment. Local transceiver 115 may provide access to a wireless local area network (WLAN, e.g., IEEE Std. 802.11 network) or wireless personal area network (WPAN, e.g., Bluetooth network). In another example implementation, local transceiver 115 may comprise a femto cell transceiver capable of facilitating communication on link 125 according to a cellular communication protocol. Of course it should be understood that these are merely examples of networks that may communicate with a mobile device over a wireless link, and claimed subject matter is not limited in this respect.

In a particular implementation, base station transceiver 110 and local transceiver 115 may communicate with servers 140, 150 and 155 over a network 130 through links 145. Here, network 130 may comprise any combination of wired or wireless links. In a particular implementation, network 130 may comprise Internet Protocol (IP) infrastructure capable of facilitating communication between mobile device 100 and servers 140, 150 or 155 through local transceiver 115 or base station transceiver 150. In another implementation, network 130 may comprise cellular communication network infrastructure such as, for example, a base station controller or master switching center (not shown) to facilitate mobile cellular communication with mobile device 100.

In particular implementations, and as discussed below, mobile device 100 may have circuitry and processing resources capable of computing a position fix or estimated location of mobile device 100. For example, mobile device 100 may compute a position fix based, at least in part, on pseudorange measurements to four or more SPS satellites 160. Here, mobile device 100 may compute such pseudorange measurements based, at least in part, on pseudonoise code phase detections in signals 159 acquired from four or more SPS satellites 160. In particular implementations, mobile device 100 may receive from server 140, 150 or 155 positioning assistance data to aid in the acquisition of signals 159 transmitted by SPS satellites 160 including, for example, almanac, ephemeris data, Doppler search windows, just to name a few examples.

In other implementations, mobile device 100 may obtain a position fix by processing signals received from terrestrial transmitters fixed at known locations (e.g., such as base station transceiver 110) using any one of several techniques such as, for example, advanced forward trilateration (AFLT) and/or observed time difference of arrival (OTDOA). In these particular techniques, a range from mobile device 100 may be measured to three or more of such terrestrial transmitters fixed at known locations based, at least in part, on pilot signals transmitted by the transmitters fixed at known locations and received at mobile device 100. Here, servers 140, 150 or 155 may be capable of providing positioning assistance data to mobile device 100 including, for example, locations and identities of terrestrial transmitters to facilitate positioning techniques such as AFLT and OTDOA. For example, servers 140, 150 or 155 may include a base station almanac (BSA) which indicates locations and identities of cellular base stations in a particular region or regions.

In particular environments such as indoor environments or urban canyons, mobile device 100 may not be capable of acquiring signals 159 from a sufficient number of SPS satellites 160 or perform AFLT or OTDOA to compute a position fix. Alternatively, mobile device 100 may be capable of computing a position fix based, at least in part, on signals acquired from local transmitters (e.g., WLAN access points positioned at known locations). For example, mobile devices may obtain a position fix by measuring ranges to three or more indoor terrestrial wireless access points which are positioned at known locations. Such ranges may be measured, for example, by obtaining a MAC ID address from signals received from such access points and obtaining range measurements to the access points by measuring one or more characteristics of signals received from such access points such as, for example, received signal strength (RSSI) or round trip time (RTT). In alternative implementations, mobile device 100 may obtain an indoor position fix by applying characteristics of acquired signals to a radio heatmap indicating expected RSSI and/or RTT signatures at particular locations in an indoor area. In particular implementations, a radio heatmap may associate identities of local transmitters (e.g., a MAD address which is discernible from a signal acquired from a local transmitter), expected RSSI from signals transmitted by the identified local transmitters, an expected RTT from the identified transmitters, and possibly standard deviations from these expected RSSI or RTT. It should be understood, however, that these are merely examples of values that may be stored in a radio heatmap, and that claimed subject matter is not limited in this respect.

As pointed out above in a particular implementation, mobile device 100 may also apply signals received from a magnetometer to signatures in a magnetic heatmap indicating expected magnetic signatures at particular locations in an indoor area. In particular implementations, for example, a “magnetic heatmap” may associate expected magnetic signatures or compass deviations with locations in an indoor area allowing a mobile device to estimate its location based, at least in part, on an association of magnetic heatmap values with compass or magnetometer measurements obtained at the mobile device.

In an alternative embodiment, a magnetic heatmap may associate expected magnetic signatures or compass deviations with a mobile devices orientation or heading. For example, such a magnetic heatmap may include expected magnetic signatures or compass deviations that may be indicative of an orientation of a mobile device. In a particular, the expected magnetic signatures or compass deviations may be further referenced to approximate locations (e.g., in a wing of a building, floor, etc.) so that a mobile device with a rough approximation of its location may apply current magnetometer or compass readings to particular expected magnetic signatures or compass deviations (referenced to the rough approximation) to estimate its heading or orientation.

In particular implementations, mobile device 100 may receive positioning assistance data for indoor positioning operations from servers 140, 150 or 155. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio heatmaps, magnetic heatmaps, locations and identities of transmitters, routeability graphs, just to name a few examples. Other assistance data received by the mobile device may include, for example, local maps of indoor areas for display or to aid in navigation. Such a map may be provided to mobile device 100 as mobile device 100 enters a particular indoor area. Such a map may show indoor features such as doors, hallways, entry ways, walls, etc., points of interest such as bathrooms, pay phones, room names, stores, etc. By obtaining and displaying such a map, a mobile device may overlay a current location of the mobile device (and user) over the displayed map to provide the user with additional context.

In one implementation, a routeability graph and/or digital map may assist mobile device 100 in defining feasible areas for navigation within an indoor area and subject to physical obstructions (e.g., walls) and passage ways (e.g., doorways in walls). Here, by defining feasible areas for navigation, mobile device 100 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, mobile device 100 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of mobile device 100.

According to an embodiment, mobile device 100 may access indoor navigation assistance data through servers 140, 150 or 155 by, for example, requesting the indoor assistance data through selection of a universal resource locator (URL). In particular implementations, servers 140, 150 or 155 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at mobile device 100 and data transmission resources may make receipt of indoor navigation assistance data for all areas served by servers 140, 150 or 155 impractical or infeasible, a request for indoor navigation assistance data from mobile device 100 may indicate a rough or course estimate of a location of mobile device 100. Mobile device 100 may then be provided indoor navigation assistance data covering areas including and/or proximate to the rough or course estimate of the location of mobile device 100.

In one particular implementation, a request for indoor navigation assistance data from mobile device 100 may specify a location context identifier (LCI). Such an LCI may be associated with a locally defined area such as, for example, a particular floor of a building or other indoor area which is not mapped according to a global coordinate system. In one example server architecture, upon entry of an area, mobile device 100 may request a first server, such as server 140, to provide one or more LCIs covering the area or adjacent areas. Here, the request from the mobile device 100 may include a rough location of mobile device 100 such that the requested server may associate the rough location with areas covered by known LCIs, and then transmit those LCIs to mobile device 100. Mobile device 100 may then use the received LCIs in subsequent messages with a different server, such as server 150, for obtaining navigation assistance data relevant to an area identifiable by one or more of the LCIs as discussed above (e.g., digital maps, locations and identifies of beacon transmitters, radio heatmaps or routeability graphs).

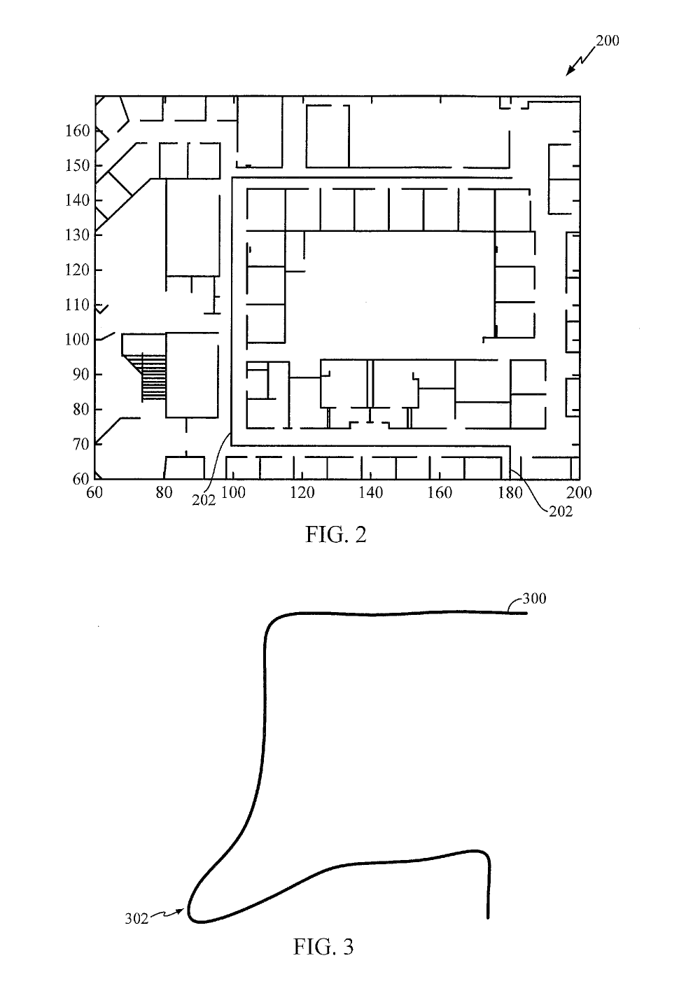

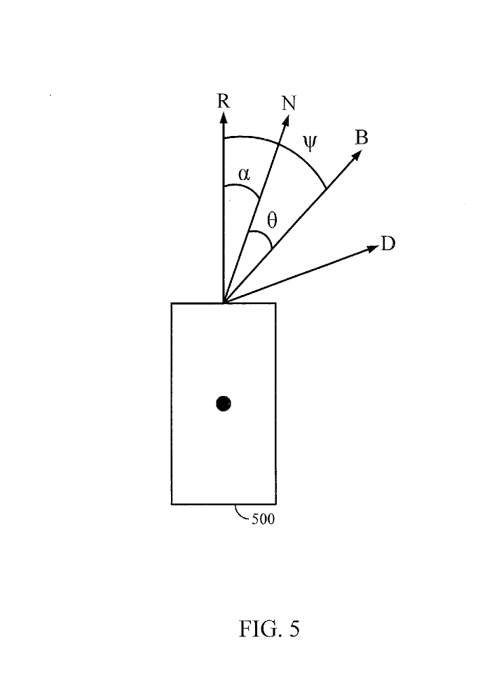

FIG. 2 shows an actual path 202 traversed by a mobile device in an indoor area over a map 200. As can be observed, the mobile device travels substantially in straight lines along hallways and corridors and makes turns at substantially right angles. In a particular implementation, the mobile device may comprise inertial sensors such as, for example, one or more accelerometers, gyroscopes or magnetometers. Using techniques known to those of ordinary skill in the art, the path travelled by the mobile device may be estimated based, at least in part, on signals or “traces” obtained from an inertial sensors. FIG. 4, for example, shows an estimate of path 202 as measured based, at least in part, on signal measurements obtained from a gyroscope.

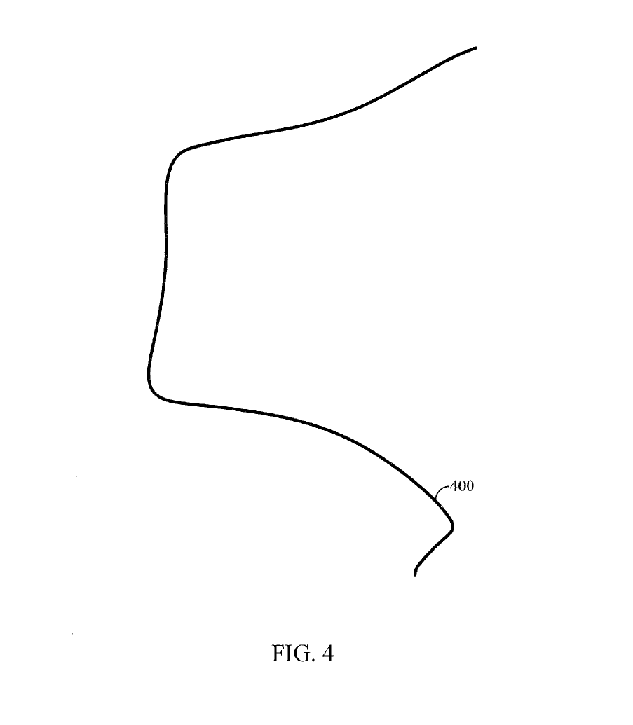

In another example, FIG. 3 shows an estimate 300 of path 202 as measured based, at least in part, on measurements obtained from a magnetometer of a mobile device. Estimate 300 may be derived, at least in part, from measurements of a heading of the mobile device relative to a reference direction such as a true North direction obtained from processing signals from the magnetometer. For example, the magnetometer may from time to time obtain a measurement of the heading of the mobile device relative to a true North direction as the mobile device travels along actual path 202 to be used in computing estimate 300. As may be observed, estimate 300 is distorted from actual path 202 at portion 302. At an area about portion 302, the magnetometer may have responded to not only a magnetic field in the true North direction, but also local magnetic fields or disturbances such as, for example, electrical machinery (e.g., electric motors, fans, power generation or distribution equipment), large metallic objects (e.g., metal doors), just to name a couple of examples. Thus, measurements obtained at the magnetometer may be responsive not only to a magnetic field in a true North direction, but also responsive to local magnetic fields or disturbances.

In another implementation, a mobile device may use assistance data to determine whether current magnetometer or compass readings are accurate. Here, previous measurements of magnetic disturbances obtained at multiple mobile devices at multiple locations may be crowdsourced (e.g., at a central server) to provide expected disturbance signatures at particular locations or areas. To generate an expected disturbance signature for a particular location or area, multiple magnetometer measurements taken from multiple mobile devices in the vicinity of the particular location or area may be combined (e.g., using weighted averaging). Subsequently, a mobile device in the vicinity of the particular location or area may apply a current compass or magnetometer measurement with the expected disturbance signature to assess whether the current compass or magnetometer measurement is reliable or accurate.

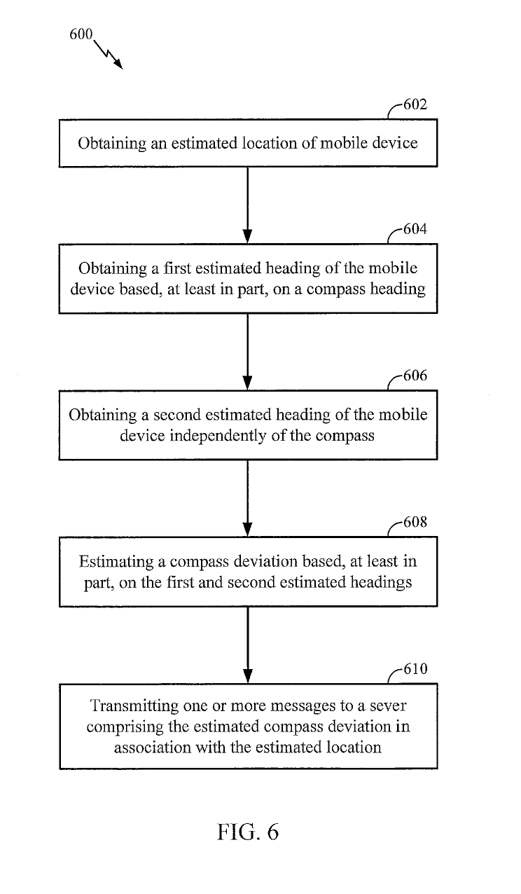

FIG. 5 illustrates an example of how a locally measured magnetic field may deviate from a true North magnetic field. A mobile device 500 may have a heading in a direction R may comprise a magnetometer capable of measuring a local magnetic field. In this context, a heading may comprise a direction or orientation of a mobile device relative to a reference direction such as, for example, a true North reference direction. For example, a heading may be determined from an angular direction that the mobile device is pointed (e.g., from the top of the mobile device as a display is pointed upward or pointed direction of the mobile device projected in a plane normal to a measured gravity vector). Here, a heading of a mobile device may be determined even if the mobile device is not moving relative to a frame of reference. As such, in this context, heading of a mobile device may be computed independently of a direction of movement of the mobile device. For example, a magnetometer may obtain measurements of a local magnetic field including a magnitude (e.g., in units of Tesla or Gauss) and a direction (e.g., relative to a heading of mobile device 500). In this particular example illustration, mobile device 500 may be in the presence of two independent magnetic fields comprising a magnetic field in a true North direction shown as vector N and a local magnetic field disturbance field shown as vector D. Here, while heading direction R may deviate from true North by an angle α, a measured magnetic field represented by a vector B may deviate from true North by an angle θ and heading direction R may deviate from measured magnetic field represented as vector B by an angle ψ. Thus, the measured magnetic field may deviate from true North magnetic field by an angle of θ=ψ−α. A magnetometer may also be capable of measuring a magnitude of a local magnetic field. For example, a magnitude of the measured magnetic field represented by vector B may also deviate from an actual or expected magnitude of true North magnetic field represented by vector N. In a particular implementation, a deviation in a locally measured magnetic field from a true North magnetic field may be characterized, at least in part, by a deviation in angular direction and/or magnitude of the locally measured magnetic field from a true North direction. It should be understood, however, that this is merely an example of how a deviation in a locally measured magnetic field from a true North magnetic field may be characterized and quantified, and claimed subject matter is not limited in this respect.

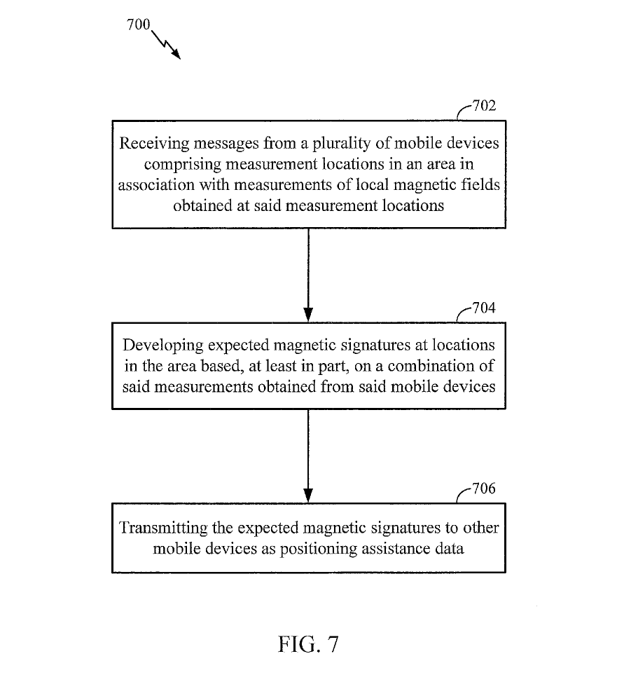

As discussed below in particular examples, a magnetic heatmap associating an expected deviation of a measured local magnetic field from a true North direction at particular discrete locations (e.g., rectangular grid points) over an area (e.g., an indoor area) from a local magnetic field may be provided as assistance data to a mobile device. By applying reference direction of a heading of the mobile device and measurements from a magnetometer to magnetic heatmap signatures, the mobile device may estimate its location. In a particular implementation a magnetic heatmap may be derived, at least in part, from magnetic measurements obtained from one or more mobile devices “crowdsourced” at a server (e.g., server 140, 150 or 155). FIG. 6 is a flow diagram of a process of obtaining magnetic measurements at a mobile device for use in deriving a magnetic heatmap.

At block 602, a mobile device may estimate its location in an area using one or more techniques discussed above in connection with FIG. 1 (e.g., acquisition of SPS signals and/or using indoor navigation techniques). Alternatively, a current location may be provided as navigation assistance data, or be entered or selected at the mobile device by a user. It should be understood, however, that these are merely examples of how an estimated location of a mobile device may be obtained, and that claimed subject matter is not limited in this respect. At block 604, a first heading (Heading_{—}1) may be estimated based, at least in part, on a compass heading or heading estimated based, at least in part, on measurements obtained from a magnetometer.

At block 606, the mobile device may obtain a second estimated heading (Heading_{—}2) based, at least in part, on signals or information generated independently of magnetometer measurements. In one example, the mobile device may comprise a camera with image recognition capabilities that enables the mobile device to estimate its heading based, at least in part, on a known rough location of the mobile device and recognition of features in an image (e.g., features at the end of a hallway or other object that indicate a heading of the mobile device). Here, a camera angle of mobile device may be pointed in a particular direction at a known angular deviation from a reference heading of the mobile device. As such, a recognition of particular features in a camera view may correlate with a specific camera angle, which may then be referenced to a heading of the mobile device. In another example, a mobile device may estimate its direction of motion relative to features of an indoor map. For example, movement of the mobile device tracked along a straight line may define a direction of measurement that may be correlated with a hallway oriented in a known direction according to the indoor map. This may indicate Heading_{—}2 to be in a direction of the hallway's lengthwise dimension. In another example, the mobile device may integrate signals from a gyroscope and/or accelerometers from an initial known location/orientation to measure a current heading and/or position. In yet another example implementation, a user may manually select or enter a heading at the mobile device. It should be understood, however, that these are merely examples of how a heading of a mobile device may be determined or measured independently of measurements taken at a magnetometer compass, and that claimed subject matter is not limited in this respect.

At block 608, a deviation in a compass reading from a true North direction may be computed based, at least in part, on a comparison of Heading_{—}1 and Heading_{—}2. As illustrated in FIG. 5, a measurement of a local magnetic field may deviate from a true North magnetic field in the presence of a local magnetic disturbance. At least a directional or angular portion of that deviation may be measured as Heading_{—}1−Heading_{—}2. A magnitude component of a compass deviation may be computed as a difference between a measured magnitude of the local magnetic field (as measured from a magnetometer or compass) and an expected magnetic field. As such, in particular implementations, a compass deviation may comprise at least of an angular component or a magnitude component, or both.

At block 610, a mobile device may transmit one or more messages to a server (e.g., server 140, 150 or 155) including the measured or estimated compass deviation based at least in part on a compass deviation measurement in association with an estimate of a location of the mobile device at a time that the compass measurement was obtained. Alternatively, the one or more messages may include merely measurements of a local magnetic field obtained at measurement locations expressed as an angle and a magnitude along with estimates of the location. Here, the mobile device may transmit messages to the server in packets transmitted according to any one of several wireless communication protocols. As described below, a server receiving these messages may combine or crowdsource measured or estimated compass deviations obtained at or about a location to derive a signature indicative of an expected compass deviation at or about the location.

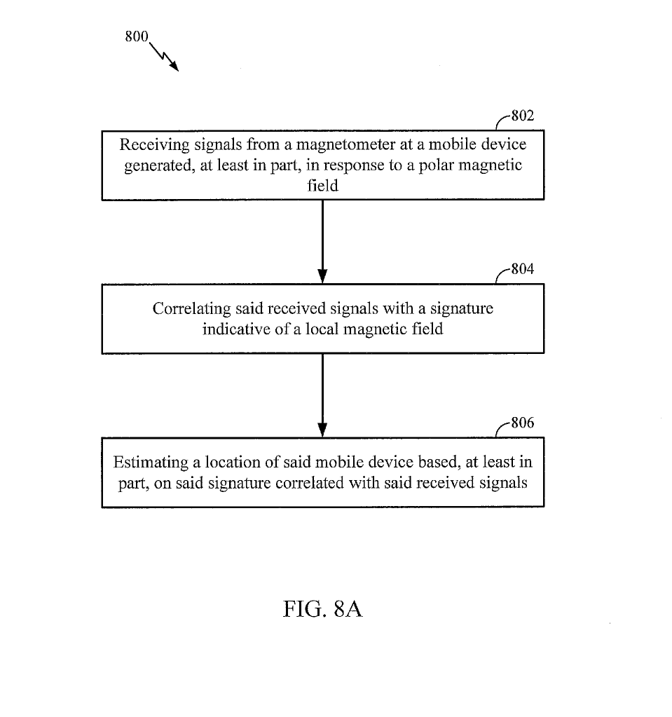

FIG. 7 is a flow diagram of a process to be performed at a computing apparatus, such as a server, to determine or compute expected magnetic signatures for use in a magnetic heatmap, according to an embodiment. Block 702 may comprise receiving messages from multiple devices associating measurement locations in an area with measurements of a local magnetic field obtained at the measurement locations. In particular implementations, messages received at block 702 may comprise messages such as those transmitted in block 610. As pointed out above, these messages may comprise measurements of local magnetic fields and/or compass deviations associated with specific locations where measurements of the local magnetic fields and/or compass deviations were obtained. In other implementations, messages from mobile devices to a server may also comprise time stamps indicating times that measurements of a local magnetic field or compass deviation is obtained.

Block 704 may comprise developing or computing expected magnetic signatures at or about locations in an area based, at least in part, on a combination of measurements obtained from messages received from multiple mobile device at block 702. In one implementation, block 704 may characterize properties of an expected magnetic field local to locations or areas within a larger area. In one example implementation, measurements of a magnetic field at a location obtained from multiple mobile devices may be filtered (e.g., averaged or weighted averaged) to estimate expected characteristics of the magnetic field local to the location. Block 704 may also compute a standard deviation of expected characteristics computed based, at least in part, on messages from multiple mobile devices. Expected characteristics of the magnetic field local to the location may include, for example, an estimated angular deviation from true North and/or magnitude of the magnetic field at the location. In addition to locations in an area, expected characteristics of a local magnetic field may be computed for time of day, day of week, etc. As pointed out above, measurements obtained from mobile devices may be accompanied by time stamps indicating time of day, day of week, etc., that particular measurements are obtained. Computed expected magnetic signatures may be stored in a memory (e.g., at a server) as a magnetic heatmap and updated from time to time as additional measurements are received. The stored heatmap may then be transmitted to other mobile devices as positioning assistance data at block 706.

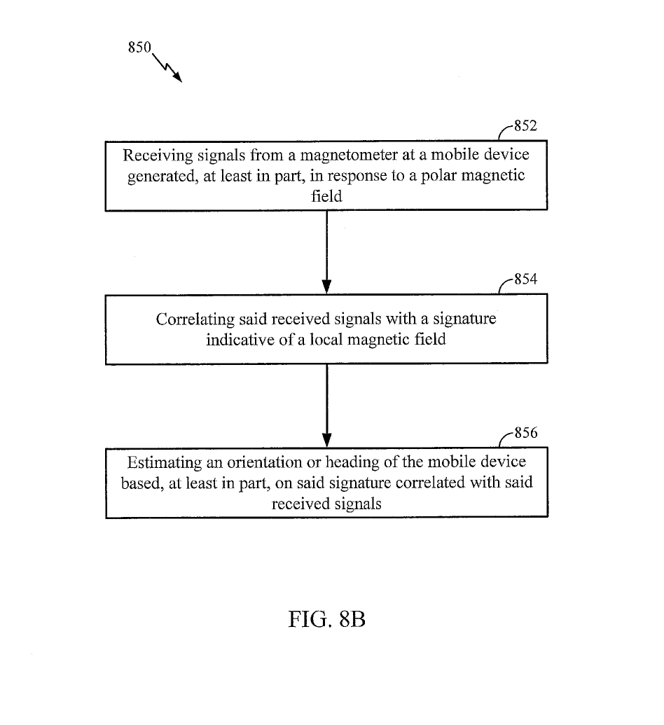

FIG. 8A is a flow diagram of a process of applying a magnetic heatmap to magnetic measurements at a mobile device for estimating a location of the mobile device. As discussed above in connection with FIG. 7, a magnetic heatmap comprising expected magnetic signatures at locations in an indoor area may be transmitted to a mobile device as positioning assistance data. At block 802, a mobile device may receive signals or measurements from a magnetometer generated, at least in part, in response to a local magnetic field. As pointed out above in connection with FIG. 5, a local magnetic field may comprise a combination of a magnetic field having a true North direction and one or more other magnetic fields responsive to one or more magnetic disturbances. Signals or measurements received from the magnetometer may then be correlated with a magnetic signature in a magnetic heatmap indicative of a local magnetic field. At block 806, the mobile device may then estimate its location based, at least in part, on a magnetic signature in the magnetic heatmap which at least closely matches the signals or measurements received from the magnetometer.

FIG. 8B shows a process 850 of applying a magnetic heatmap to magnetic measurements at a mobile device for estimating an orientation or heading of the mobile device. As pointed out above, a magnetic heatmap may include expected magnetic signatures at locations or regions. At block 852, the mobile device may receive signals or measurements from a magnetometer generated, at least in part, in response to a local magnetic field as discussed above at block 802 of process 800. Here, if the mobile device knows its rough location, the mobile device can determine an expected magnetic signature indicative of a local magnetic field about the rough location. This rough location may be determined, for example, based on a last position fix obtained at the mobile device using any of the aforementioned techniques. For example, an approximate or rough location may be determined by propagating a last position fix with measurements obtained by inertial sensors. Alternatively, the rough position may be manually entered by a user/operator of the mobile device (e.g., by manually selecting a room displayed on a touchscreen device). It should be understood, however, that these are merely examples of how a mobile device may determine its rough location and claimed subject matter is not limited in these respects.

Block 854 may correlate the signals received from the magnetometer with the expected magnetic signature. The correlated signature may then be used to estimate an orientation or heading of the mobile device at block 856. As pointed out above, a measured magnetic field may deviate from true North magnetic field by an angle of θ=ψ−α and a heading direction R may deviate from measured magnetic field represented as vector B by angle ψ. Furthermore, heading direction R may deviate from true North by angle α. Thus, heading direction R may be derived from angle α, which may be derived from θ (e.g., obtained as an expected magnetic signature associated with a mobile device's rough location in a magnetic heatmap) and ψ (e.g., based on signals or measurements from a magnetometer or compass).

In an alternative embodiment, a mobile device may use the signals received at block 802 to determine the strength of the local magnetic disturbance and thereby assess reliability of its own compass measurements.

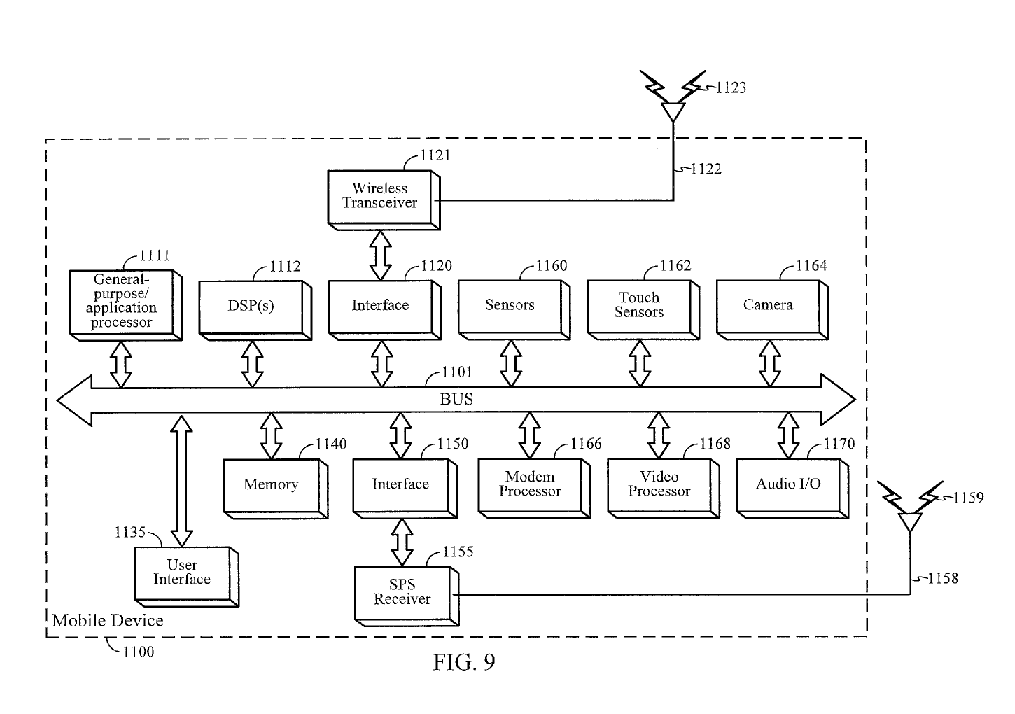

FIG. 9 is a schematic diagram of a mobile device according to an embodiment. Mobile device 100 (FIG. 1) may comprise one or more features of mobile device 1100 shown in FIG. 9. In certain embodiments, mobile device 1100 may also comprise a wireless transceiver 1121 which is capable of transmitting and receiving wireless signals 1123 via an antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, WiFi, CDMA, WCDMA, LTE and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown).

Also shown in FIG. 9, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

Also shown in FIG. 9, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

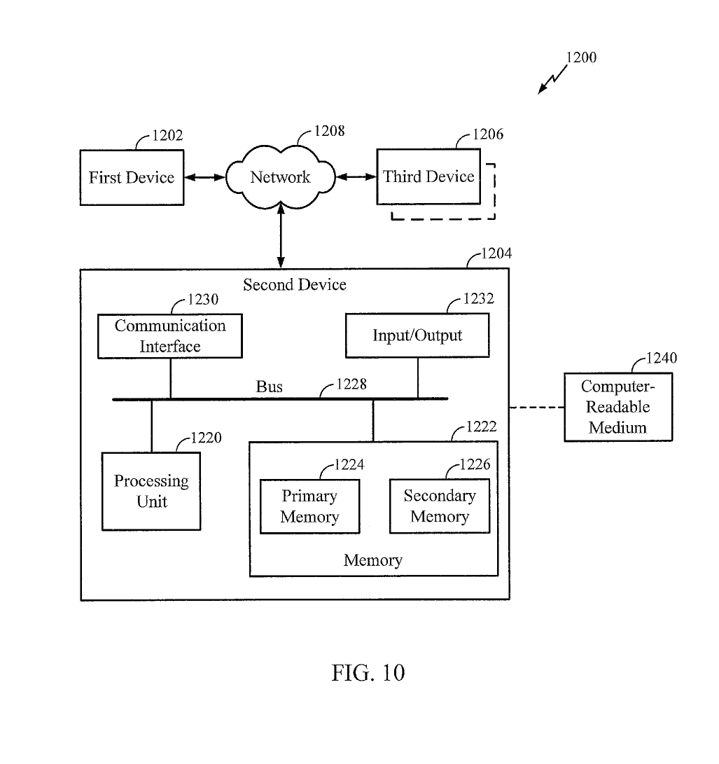

FIG. 10 is a schematic diagram illustrating an example system 1200 that may include one or more devices configurable to implement techniques or processes described above, for example, in connection with FIG. 1. System 1200 may include, for example, a first device 1202, a second device 1204, and a third device 1206, which may be operatively coupled together through a wireless communications network 1208. In an aspect, first device 1202 may comprise a server capable of providing positioning assistance data such as, for example, a base station almanac. First device 1202 may also comprise a server capable of providing an LCI to a requesting mobile device based, at least in part, on a rough estimate of a location of the requesting mobile device. First device 1202 may also comprise a server capable of providing indoor positioning assistance data relevant to a location of an LCI specified in a request from a mobile device. Second and third devices 1204 and 1206 may comprise mobile devices, in an aspect. Also, in an aspect, wireless communications network 1208 may comprise one or more wireless access points, for example. However, claimed subject matter is not limited in scope in these respects.

First device 1202, second device 1204 and third device 1206, as shown in FIG. 10, may be representative of any device, appliance or machine that may be configurable to exchange data over wireless communications network 1208. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, wireless communications network 1208, as shown in FIG. 10, is representative of one or more communication links, processes, or resources configurable to support the exchange of data between at least two of first device 1202, second device 1204, and third device 1206. By way of example but not limitation, wireless communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise co-located/coupled with processing unit 1220.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1030 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femto cell, utilized to extend cellular telephone service into a business or home. In such an implementation, one or more mobile devices may communicate with a femto cell via a code division multiple access (“CDMA”) cellular communication protocol, for example, and the femto cell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method comprising, at a mobile device:
receiving signals from a magnetometer generated, at least in part, in response to a polar magnetic field;
correlating said received signals with a signature indicative of a local magnetic field; and
estimating a location of said mobile device based, at least in part, on said signature correlated with said received signals.

2. The method of claim 1, and further comprising updating an estimated direction of motion of the mobile device relative to a map based, at least in part, on said estimated location and signals received from an accelerometer or gyroscope.

3. The method of claim 1, wherein said signature is based, at least in part, on a combination of crowd-sourced magnetometer readings received from multiple mobile devices.

4. The method of claim 1, wherein said signature comprises an angular direction of an expected magnetic field local to said estimated location.

5. The method of claim 4, wherein said signature further comprises a magnitude of said expected magnetic field local to said estimated location.

6. The method of claim 1, wherein said signature comprises an expected compass deviation local to said estimated location.

7. The method of claim 6, wherein said correlating said received signals with said signature indicative of said local magnetic field further comprises:
determining a compass heading of said mobile device based, at least in part, on said signals received from said magnetometer;
determining a reference heading of said mobile device independently of said signals received from said magnetometer; and
comparing said signature to a difference between said compass heading and said reference heading.

8. The method of claim 7, wherein said determining said reference heading further comprises:
capturing an image of an object at a camera imager;
inferring a directional orientation of the mobile device based, at least in part, on the captured image.

9. A mobile device comprising:
a magnetometer to generate signals at least in part in response to a polar magnetic field; and
a processor to:
correlate said generated signals with a signature indicative of a local magnetic field; and
estimate a location of said mobile device based, at least in part, on said signature correlated with said generated signals.

10. An article comprising:
a non-transitory storage medium comprising machine-readable instructions stored thereon which are executable by a special purpose computing apparatus at a mobile device to:
correlate signals generated by a magnetometer at least in part in response to a polar magnetic field with a signature indicative of a local magnetic field; and
estimate a location of said mobile device based, at least in part, on said signature correlated with said generated signals.

11. An apparatus comprising:
means for generating signals at least in part in response to a polar magnetic field;
means for correlating said generated signals with a signature indicative of a local magnetic field; and
means for estimating a location of a mobile device based, at least in part, on said signature correlated with said received signals.

12. A method comprising:
receiving messages from a plurality of mobile devices including measurement locations in an indoor area in association with measurements of a local magnetic field obtained at said measurement locations;
developing expected magnetic signatures over locations in said indoor area based, at least in part, on a combination of said measurements obtained from said mobile devices; and
transmitting said expected magnetic signatures to other mobile devices as indoor positioning assistance data.

13. The method of claim 12, wherein said measurements of magnetic disturbances further comprises a compass deviation determined based, at least in part, on a first heading and a second heading.

14. The method of claim 13, wherein said compass deviation comprises an angular deviation from a true North direction and a magnetic field magnitude component.

15. The method of claim 14, wherein the first heading comprises a heading estimated in reference to said true North direction.

16. The method of claim 14, wherein the second heading comprises a heading determined according to a compass measurement.

17. The method of 12, wherein said expected magnetic signatures comprise at least expected angular deviations of magnetic fields local to said locations in said indoor area.

18. The method of claim 17, wherein said expected magnetic signatures further comprise at least standard deviations of said expected angular deviations.

19. The method of claim 18, wherein said expected magnetic signatures further comprise at least expected magnitudes of local magnetic fields and standard deviations of said expected magnitudes of said local magnetic fields.

20. A server comprising:
a receiver to receive messages from a communication network;
a transmitter to transmit messages to said communication network; and
one or more processors to:
obtain from messages received at said receiver originating at a plurality of mobile devices measurement locations in an indoor area in association with measurements of magnetic fields local to said measurement locations;
develop expected magnetic signatures over locations in said indoor area based, at least in part, on a combination of said measurements obtained from said mobile devices; and
initiate transmission of said expected magnetic signatures through said transmitter to other mobile devices as indoor positioning assistance data.

21. An article comprising:
a non-transitory storage medium comprising machine-readable instructions stored thereon which are executable by a special purpose computing apparatus to:
obtain from messages originating at a plurality of mobile devices measurement locations in an indoor area in association with measurements of magnetic fields local to said measurement locations;
develop expected magnetic signatures over locations in said indoor area based, at least in part, on a combination of said measurements obtained from said mobile devices; and
initiate transmission of said expected magnetic signatures to other mobile devices as indoor positioning assistance data.

22. An apparatus comprising:
means for receiving messages from a plurality of mobile devices including measurement locations in an indoor area in association with measurements of a local magnetic field obtained at said measurement locations;
means for developing expected magnetic signatures over locations in said indoor area based, at least in part, on a combination of said measurements obtained from said mobile devices; and
means for transmitting said expected magnetic signatures to other mobile devices as indoor positioning assistance data.

23. A method comprising, at a mobile device:
obtaining an estimated location of the mobile device;
obtaining a first estimated heading of the mobile device based, at least in part, on one or more measurements obtained from a magnetometer;
obtaining a second estimated heading of the mobile device independently of said one or more measurements obtained from said magnetometer;
estimating a compass deviation based, at least in part, on said first and second estimated headings; and
transmitting one or more messages to a server comprising said estimated compass deviation in association with said estimated location.

24. The method of claim 23, wherein said estimated compass deviation comprises an estimated angular deviation.

25. The method of claim 24, wherein said estimated compass deviation further comprises a magnetic field magnitude component.

26. The method of claim 23, wherein obtaining the second estimated heading independently of said one or more measurements obtained from said magnetometer further comprises:
capturing an image of an object at a camera imager;
inferring a directional orientation of the mobile device based, at least in part, on the captured image.

27. The method of claim 23, wherein obtaining the second estimated heading independently of said one or more measurements obtained from said magnetometer further comprises:
tracking movement of said mobile device on a trajectory;
associating said trajectory with a path expressed in a digital map; and
determining said second estimated heading based, at least in part, on a direction of said pathway.

28. The method of claim 27, wherein said second estimated heading is further determined based, at least in part, on an orientation of said mobile device relative to said direction of said pathway.

29. A mobile device comprising:
magnetometer to generate measurements responsive to a magnetic field;
a transmitter to transmit messages through a communication network; and
a processor to:
obtain a first estimated heading of the mobile device based, at least in part, on one or more measurements obtained from said magnetometer;
obtain a second estimated heading of the mobile device independently of said one or more measurements obtained from said magnetometer;
estimate a compass deviation based, at least in part, on said first and second estimated headings; and
initiate transmission of one or more messages through said transmitter to a server, said one or more messages comprising said estimated compass deviation in association with said estimated location.

30. An article comprising:
a non-transitory storage medium comprising machine-readable instructions stored thereon which are executable by a special purpose computing apparatus to:
compute a first estimated heading of a mobile device based, at least in part, on one or more measurements obtained from a magnetometer;
compute a second estimated heading of the mobile device independently of said one or more measurements obtained from said magnetometer;
estimate a compass deviation based, at least in part, on said first and second estimated headings; and
initiate transmission of one or more messages to a server, said one or more messages comprising said estimated compass deviation in association with said estimated location.

31. An apparatus comprising:
means for obtaining an estimated location of the mobile device;
means for obtaining a first estimated heading of the mobile device based, at least in part, on one or more measurements obtained from a magnetometer;
means for obtaining a second estimated heading of the mobile device independently of said one or more measurements obtained from said magnetometer;
means for estimating a compass deviation based, at least in part, on said first and second estimated headings; and
means for transmitting one or more messages to a server comprising said estimated compass deviation in association with said estimated location.

32. A method comprising, at a mobile device:
receiving signals from a magnetometer generated, at least in part, in response to a polar magnetic field;
correlating said received signals with a signature indicative of a local magnetic field; and
estimating an orientation or heading of the mobile device based, at least in part, on said signature correlated with said received signals.

33. The method of claim 32, wherein said signature indicative of a local magnetic field is selected based, at least in part, on a rough location of said mobile device.

34. The method of claim 33, wherein said rough location of said mobile device is based, at least in part, on a previous position fix obtained at said mobile device.

35. The method of claim 33, wherein said rough location is determined based on a user input selection.

36. A mobile device comprising:
a magnetometer to generate signals at least in part in response to a polar magnetic field; and
a processor to:
correlate said received signals with a signature indicative of a local magnetic field; and
estimate an orientation or heading of the mobile device based, at least in part, on said signature correlated with said received signals.

37. An article comprising:
a non-transitory storage medium comprising machine-readable instructions stored thereon which are executable by a special purpose computing apparatus at a mobile device to:
correlate said received signals with a signature indicative of a local magnetic field; and
estimating an orientation or heading of the mobile device based, at least in part, on said signature correlated with said received signals.

38. An apparatus comprising:
means for receiving signals from a magnetometer at a mobile device, the signals being generated, at least in part, in response to a polar magnetic field;
means for correlating said received signals with a signature indicative of a local magnetic field; and
means for estimating an orientation or heading of the mobile device based, at least in part, on said signature correlated with said received signals.
